(19) United States
(12) Patent Application Publication
(10) Pub. No.: US 2026/0202208 A1
(43) Pub. Date: Jul. 16, 2026

(54) VOICE REPORT-BASED NAVIGATION MAP SERVICE SYSTEM AND METHOD

(71) Applicant: HYUNDAI AUTOEVER CORP., Seoul (KR)

(72) Inventors: Mi Ri Kim, Seoul (KR); Sang Hyup Lee, Seoul (KR)

(73) Assignee: HYUNDAI AUTOEVER CORP., Seoul (KR)

(21) Appl. No.: 19/431,815

(22) Filed: Dec. 23, 2025

(30) Foreign Application Priority Data
Jan. 15, 2025 (KR) 10-2025-0006195

(51) Int. Cl. G01C 21/36; G10L 15/26

(52) U.S. Cl. CPC G01C 21/3629; G01C 21/3602; G01C 21/3647; G10L 15/26

(57) ABSTRACT

A voice report-based navigation map service system includes a memory and a processor configured to convert user report content input through voice by a user during driving into text by using voice recognition and store the text in the memory. The processor is also configured to update the user report content converted into the text by using vehicle location coordinates at a time when the user report content is input. The processor is additionally configure to visually display the updated report content on a navigation map.

### CROSS-REFERENCE TO RELATED APPLICATION

This application claims the benefit of and priority to Korean Patent Application No. 10-2025-0006195, filed on Jan. 15, 2025, the entire contents of which are hereby incorporated herein by reference.

### TECHNICAL FIELD

The present disclosure relates to a voice report-based navigation map service system and method.

### BACKGROUND

The statements in this section merely provide background information related to the present disclosure and may not constitute prior art.

With the recent development of technology, the number of companies that provide map information, such as location information, wayfinding, and information on nearby stores, is increasing. The map information providing service not only searches for spaces, but also connects information on all spaces such as places, buses, subways, and roads into a single search. In addition, the map information providing service is being developed to provide living information on stores, such as restaurants, convenience stores, and cafes, around locations to be found.

Vehicles typically provide the aforementioned map information service through navigation devices. The navigation device checks the current location of the vehicle, searches for an optimal route to a destination based on map data already stored in a memory, and guides the vehicle. In addition, the navigation device may also provide an optimal route to a destination in consideration of real-time traffic information collected using a communication network.

However, recently, various reporting services, such as highway accident reports, are being changed from reporting services unilaterally provided by service providers to reporting services in which users directly participate via mobile devices. However, in the case of the user direct participation type in the related art, when a user directly presses a navigation screen (for example, for five seconds) to display a pop-up window, report is made by selecting a report item in the pop-up window. Therefore, there is a problem in that an accident may occur because a driver does not properly keep his/her eyes on the road.

### SUMMARY

Various embodiments of the present disclosure provide a voice report-based navigation map service system and method in which a customer can safely and conveniently report while keeping his/her eyes on the road while driving by improving a user reporting method into voice recognition and providing a navigation map service.

According to an aspect of the present disclosure, a voice report-based navigation map service system is provided. The voice report-based navigation map service system includes a memory and a processor. The processor is configured to convert user report content input through by a user during driving into text using voice recognition. The processor is also configured to store the text in the memory. The processor is additionally configured to update the user report content converted into the text by using vehicle location coordinates at a time when the user report content is input. The processor is also configured to visually display the updated report content on a navigation map.

In an embodiment of the present disclosure, the processor may be configured to acquire image recognition data within a certain radius based on the vehicle location coordinates, and determine a point where the user report content converted into the text is to be displayed within the navigation map through spatial analysis based on the vehicle location coordinates and the image recognition data.

In an embodiment of the present disclosure, the processor may be configured to acquire image recognition data within a certain radius based on the vehicle location coordinates, and spatially join the vehicle location coordinates and the image recognition data to determine whether changes occur in an actual site corresponding to the user report content.

In an embodiment of the present disclosure, the processor may be configured to generate a machine learning model by using a data set related to user report content prepared in advance, classify requests of the user by using the machine learning model, and reflect the classified requests in a database.

In an embodiment of the present disclosure, the processor may be configured to categorize the user report content converted into the text by using the machine learning model based on the database, update a result of the categorization, and visually displays the user report content on the navigation map based on a result of the update.

In an embodiment of the present disclosure, the processor may be configured to acquire a vehicle heading angle at a time when the user report content is input, and visually display the vehicle heading angle on the navigation map based on a result of the update together with the user report content converted into the text.

In an embodiment of the present disclosure, the processor may be configured to, based on determining that a virtual report button displayed on a screen of a navigation terminal is operated, convert user report content input in voice into text, and acquire vehicle location coordinates and a vehicle heading angle at a time when the report button is operated.

In an embodiment of the present disclosure, the processor may be configured to, based on determining that a physical report button provided on one side of a navigation terminal is operated, convert user report content input in voice into text, and acquire vehicle location coordinates and a vehicle heading angle at a time when the report button is operated.

According to another aspect of the present disclosure, a voice report-based navigation map service method is provided. The voice report-based navigation map service method includes converting, by a processor, user report content input through voice by a user during driving into text using voice recognition. The voice report-based navigation map service method also includes storing the text in a memory. The voice report-based navigation map service method additionally includes updating, by the processor, the user report content converted into the text by using vehicle location coordinates at a time when the user report content is input. The voice report-based navigation map service method also includes visually displaying, by the processor, the updated report content on a navigation map.

In an embodiment of the present disclosure, visually displaying the updated report content on the navigation map may include acquiring image recognition data within a certain radius based on the vehicle location coordinates, and determining a point where the user report content converted into the text is to be displayed within the navigation map through spatial analysis based on the vehicle location coordinates and the image recognition data.

In an embodiment of the present disclosure, visually displaying the updated report content on the navigation map may include acquiring image recognition data within a certain radius based on the vehicle location coordinates, and spatially joining the vehicle location coordinates and the image recognition data to determine whether changes occur in an actual site corresponding to the user report content.

In an embodiment of the present disclosure, the voice report-based navigation map service method may further include generating, by the processor, a machine learning model by using a data set related to user report content prepared in advance. The voice report-based navigation map service method may also include classifying, by the processor, requests of the user by using the generated machine learning model. The voice report-based navigation map service method may additionally include reflecting, by the processor, the classified requests in a database.

In an embodiment of the present disclosure, visually displaying the updated report content on the navigation map may include categorizing the user report content converted into the text by using the machine learning model based on the database, and updating a result of the categorization and visually displaying the user report content on the navigation map based on a result of the update.

In an embodiment of the present disclosure, visually displaying the updated report content on the navigation map may include acquiring a vehicle heading angle at a time when the user report content is input, and visually displaying the vehicle heading angle on the navigation map based on a result of the update together with the user report content converted into the text.

In an embodiment of the present disclosure, acquiring the vehicle heading angle may include converting user report content input in voice into text based on determining that a virtual report button displayed on a screen of a navigation terminal is operated, and acquiring vehicle location coordinates and a vehicle heading angle at a time when the report button is operated.

In an embodiment of the present disclosure, acquiring the vehicle heading angle may include converting user report content input in voice into text when a physical report button provided on one side of a navigation terminal is operated, and acquiring vehicle location coordinates and a vehicle heading angle at a time when the report button is operated.

According to another aspect of the present disclosure, a voice report-based navigation map service system includes a memory and a server. The server is configured to receive voice data, vehicle location coordinates, and a vehicle heading angle from a navigation terminal. The server is also configured to convert the voice data into text and store the text in the memory together with the vehicle location coordinates and the vehicle heading angle. The server is additionally configured to generate navigation information by using the text, the vehicle location coordinates, and the vehicle heading angle.

In an embodiment of the present disclosure, the server may be configured to provide the navigation information to the navigation terminal to visually display user report content on a navigation map of the navigation terminal.

In an embodiment of the present disclosure, the server may be configured to acquire image recognition data within a certain radius based on the vehicle location coordinates, and determine a point where the user report content converted into the text is to be displayed within the navigation map through spatial analysis based on the vehicle location coordinates and the image recognition data.

In an embodiment of the present disclosure, the server may be configured to generate a machine learning model by learning a data set related to user report content stored in a database, automatically classify requests of the user by using the generated machine learning model, and reflect the automatically classified requests in a database.

In an embodiment of the present disclosure, the server may be configured to categorize the user report content converted into the text by using the machine learning model based on the database, update a result of the categorization, and generate the navigation information based on a result of the update.

In accordance with aspects of the present disclosure, by improving a user reporting method into voice recognition and providing a navigation map service, a customer can report safely and conveniently while keeping his/her eyes on the road while driving.

In accordance with aspects of the present disclosure, a reporting method is easy and is not limited to content, so that a nationwide monitoring channel can be established.

In accordance with aspects of the present disclosure, user's request intent can be automatically ascertained through a machine learning model, and map information can be displayed on a navigation through image recognition data.

In accordance with aspects of the present disclosure, user's (e.g., customer's) requests can be automatically classified through a machine learning model trained by preprocessing user reporting cases, and can be ascertained based on the automatic classification, so that confirmation by a person in charge can be made without an intermediate step.

### BRIEF DESCRIPTION OF THE DRAWINGS

FIG. 1 is a block diagram for explaining a voice report-based navigation map service system in accordance with an embodiment of the present disclosure.

FIGS. 2-4 are diagrams for explaining an example of an operation process of the voice report-based navigation map service system in accordance with an embodiment of the present disclosure.

FIGS. 5-7 are diagrams for explaining a spatial analysis logic based on vehicle location coordinates and image recognition data in accordance with an embodiment of the present disclosure.

FIG. 8 is a flowchart for explaining a voice report-based navigation map service method in accordance with an embodiment of the present disclosure.

### DETAILED DESCRIPTION

The advantages and features of the present disclosure and methods for achieving them should become more apparent from the following detailed description taken in conjunction with the accompanying drawings. However, the present disclosure is not limited to the described embodiments and may be realized in various forms. The embodiments described below are provided to make the present disclosure thorough and complete and to enable those having ordinary skill in the art to which the present disclosure pertains to completely understand the scope of the present disclosure. The present disclosure is defined only by the scope of the appended claims. The same reference numerals are used to designate the same elements throughout the specification.

In addition, example embodiments of the present disclosure described below are provided in each system function configuration in order to efficiently explain technical components constituting the present disclosure. System function configurations commonly provided in the technical field to which the present disclosure pertains are omitted as much as possible, and function configurations additionally provided for the present disclosure are mainly described. Those having ordinary skill in the art to which the present disclosure pertains should clearly understand the functions of components that are well known among the functional configurations that are not illustrated below, and should also clearly understand the relationship between the components omitted as described above and the components added for the present disclosure.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

In addition, in the following description, terms “transfer”, “communication”, “transmission”, and “reception” of signals or information, and terms having other similar meanings, include not only direct transfer of signals or information from one component to another component, but also transfer via another component. In particular, “transfer” or “transmission” of signals or information to one component indicates a final destination of the signals or information, and does not mean a direct destination. The same applies to “reception” of signals or information.

Embodiments of the present disclosure are described below in detail with reference to the accompanying drawings.

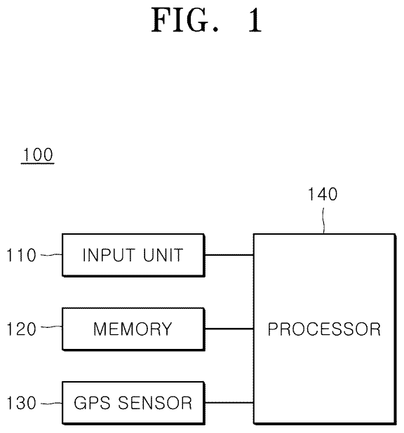

FIG. 1 is a block diagram for explaining a voice report-based navigation map service system in accordance with an embodiment of the present disclosure.

Referring to FIG. 1, a voice report-based navigation map service system 100 in accordance with an embodiment of the present disclosure may include an input unit 110, a memory 120, a GPS sensor 130, and a processor 140.

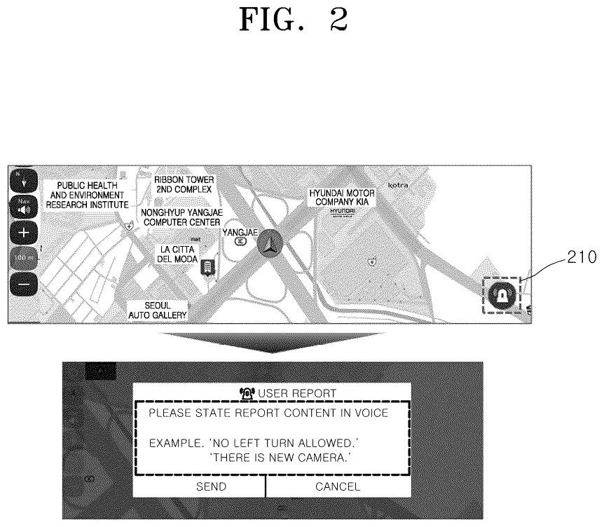

The input unit 110 may receive voice recognition from a user (e.g., a driver) while driving. In an embodiment, the input unit 110 may include a virtual button 210 for user voice recognition on a navigation screen as illustrated in FIG. 2.

When the user presses the button 210 for the purpose of report, a message such as “Please say report content in voice” may be displayed on the navigation screen, and accordingly, the user may input report content in voice through the input unit 110.

The user report content input through the input unit 110 may be converted into text by the processor 140, and the text may be stored in the memory 120. In addition, the memory 120 may store at least one instruction that is executed by the processor 140.

The memory 120 may be implemented as an internal memory such as a ROM (for example, an electrically erasable programmable read only memory (EEPROM)) or a RAM included in the processor 140, or may also be implemented as a memory separate from the processor 140.

For example, the memory 120 may be implemented as a memory embedded in the voice report-based navigation map service system 100 or may be implemented as a memory detachable from the voice report-based navigation map service system 100, depending on the purpose of data storage.

In an embodiment, data for driving the voice report-based navigation map service system 100 may be stored in a memory 120 embedded in the voice report-based navigation map service system 100, and data for expanded functions of the voice report-based navigation map service system 100 may be stored in a memory 120 detachable from the voice report-based navigation map service system 100.

The memory 120 embedded in the voice report-based navigation map service system 100 may be implemented as at least one of a volatile memory (for example, a dynamic RAM (DRAM), a static RAM (SRAM), or a synchronous dynamic RAM (SDRAM)), a non-volatile memory (for example, a one-time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash or a NOR flash)), a hard drive, or a solid state drive (SSD)).

The memory 120 detachable from the voice report-based navigation map service system 100 may be implemented in a type such as a memory card (for example, a compact flash (CF), a secure digital (SD), a micro-SD (micro secure digital), a mini-SD (mini secure digital), an extreme digital (xD), a multi-media card (MMC), and the like), or an external memory (for example, a USB memory) connectable to a USB port.

The GPS sensor 130 may measure vehicle location coordinates in cooperation with the input unit 110. For example, the GPS sensor 130 may measure vehicle location coordinates at the time when the button 210 provided on the navigation screen of FIG. 2 is pressed, i.e., the time when user report content is input.

The processor 140 may convert user report content input through voice recognition of the user while driving into text, may store the text in the memory 120, and may visually display the user report content converted into the text on a navigation map by using vehicle location coordinates at the time when the user report content is input.

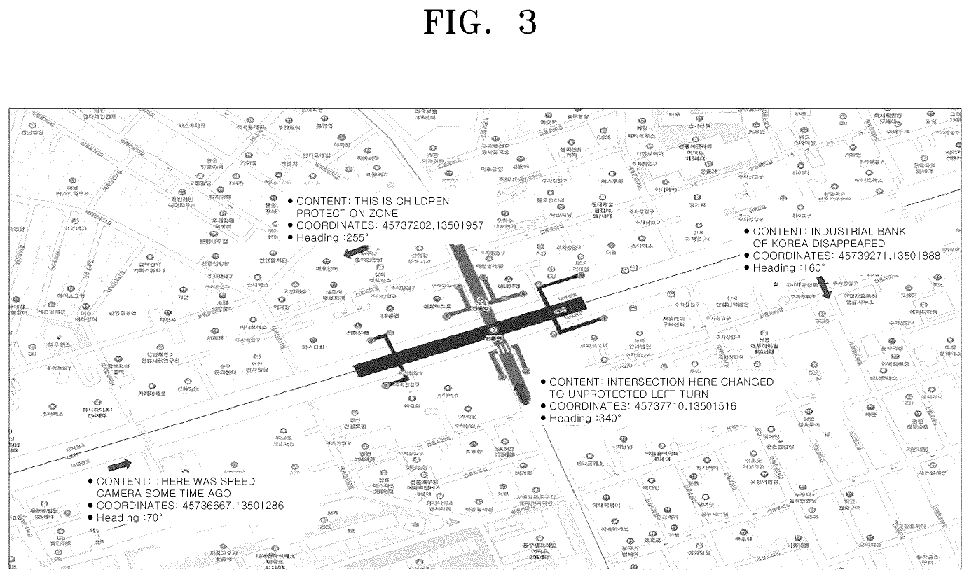

For example, as illustrated in FIG. 3, the processor 140 may visually display a vehicle heading angle at the vehicle location coordinates on the navigation map together with the user report content converted into the text.

In an embodiment, when a virtual report button displayed on the screen of a navigation terminal is operated, the processor 140 may convert user report content input in voice into text, and may acquire vehicle location coordinates and a vehicle heading angle at the time when the report button is clicked.

The processor 140 may thus acquire the vehicle location coordinates and the vehicle heading angle at the time when the user report content is input, and may display the acquired vehicle location coordinates and vehicle heading angle on the navigation screen together with the user report content converted into the text.

In addition, when a physical report button provided on one side of the navigation terminal is operated, the processor 140 may convert user report content input in voice into text, may acquire vehicle location coordinates and a vehicle heading angle at the time when the report button is clicked, and may display the acquired vehicle location coordinates and vehicle heading angle on the navigation screen together with the user report content converted into the text.

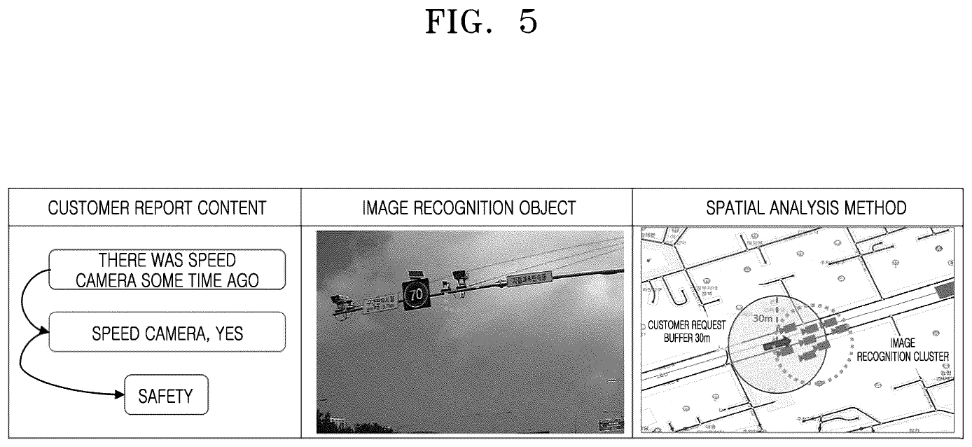

In an embodiment, the processor 140 may acquire image recognition data within a certain radius based on the vehicle location coordinates, and may determine a point where the user report content converted into the text is to be automatically input within the navigation map through spatial analysis based on the vehicle location coordinates and the image recognition data. This is described in more detail below with reference to FIGS. 5-7 .

In addition, the processor 140 may acquire image recognition data within a certain radius based on the vehicle location coordinates, and may spatially join the vehicle location coordinates and the image recognition data to check whether changes occur in an actual site.

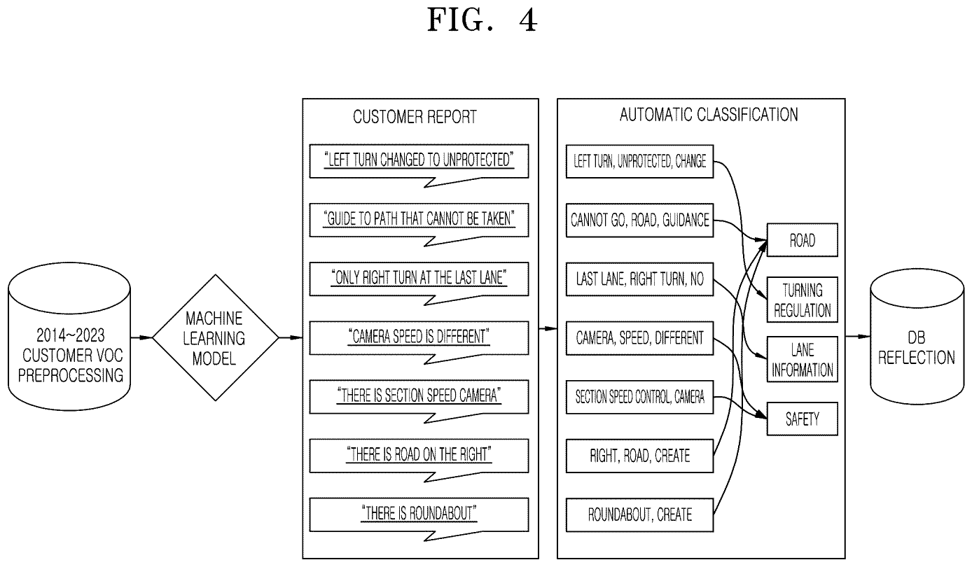

In an embodiment, the processor 140 may generate a machine learning model by using a data set related to user report content prepared in advance. For example, the processor 140 may generate the data set by preprocessing a certain amount of, e.g., 10 years of, customer reports as illustrated in FIG. 4, and may generate the machine learning model through learning based on the generated data set.

The processor 140 may automatically classify user's requests (customer reports) by using the generated machine learning model, and may reflect the automatically classified requests in a database (DB).

For example, when the customer report content is “left turn changed to unprotected,” the processor 140 may extract keywords such as “left turn”, “unprotected”, and “changed” from the customer report content through the machine learning model, and may automatically classify the customer report content into a category called “road” based on the extracted keywords.

In this way, the processor 140 may categorize the user report content converted into the text by using the machine learning model based on the database, thereby quickly ascertaining a customer's request to allow a person in charge to check the request without an intermediate step. The processor 140 may visually display the result of the categorization on the navigation map.

Embodiments of the present disclosure described above may operate based on a server. For example, the server may receive voice data, vehicle location coordinates, and a vehicle heading angle from a navigation terminal, may convert the voice data into text, and may store the text in the memory 120 together with the vehicle location coordinates and the vehicle heading angle.

The server may generate navigation information by using the text, the vehicle location coordinates, and the vehicle heading angle, and may provide the generated navigation information to the navigation terminal to visually display user report content on the navigation map of the navigation terminal.

In an embodiment, the server may acquire image recognition data within a certain radius based on the vehicle location coordinates. The server may determine a point where the user report content converted into the text is to be automatically input within the navigation map through spatial analysis based on the vehicle location coordinates and the image recognition data. Information on the point determined in this way may be included in the navigation information.

The server may generate a machine learning model by learning a dataset related to user report content stored in a database. The server may automatically classify user's requests by using the generated machine learning model, and may reflect the automatically classified requests in the database.

Accordingly, the server may categorize the user report content converted into the text by using the machine learning model based on the database. The server may generate the navigation information by reflecting the result of the categorization, and may transmit the generated navigation information to the navigation terminal.

FIGS. 5-7 are diagrams for explaining a spatial analysis logic based on vehicle location coordinates and image recognition data in accordance with an embodiment of the present disclosure.

First, referring to FIGS. 1 and 5, the processor 140 may generate an image recognition cluster minimum surface in consideration of a customer-requested point coordinate buffer 30 m. When an intersection surface exists, the processor 140 may input safety data to the customer-requested point coordinate and map the coordinate to a minimum distance road. Subsequently, worker inspection may be performed.

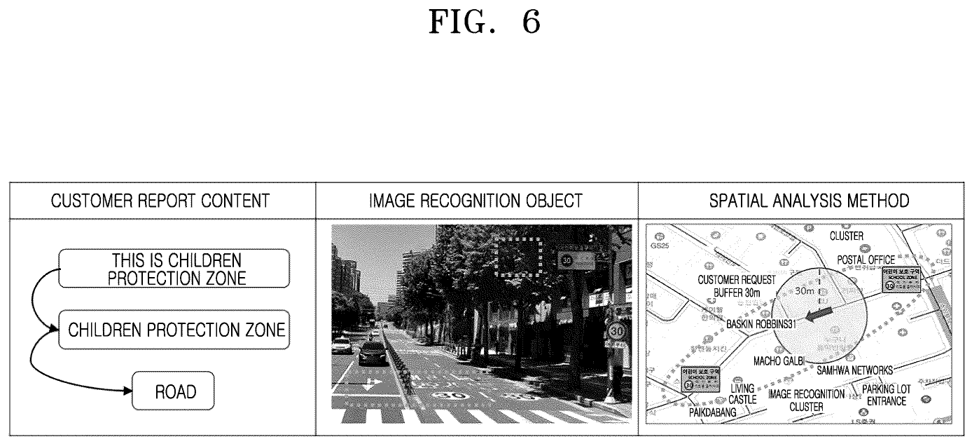

Referring now to FIGS. 1 and 6, the processor 140 may generate an image recognition cluster minimum surface in consideration of a customer-requested point coordinate buffer 30 m. The processor 140 may specify a continuous road within the image recognition cluster surface and input an attribute to the background of the specified road. Subsequently, worker inspection may be performed.

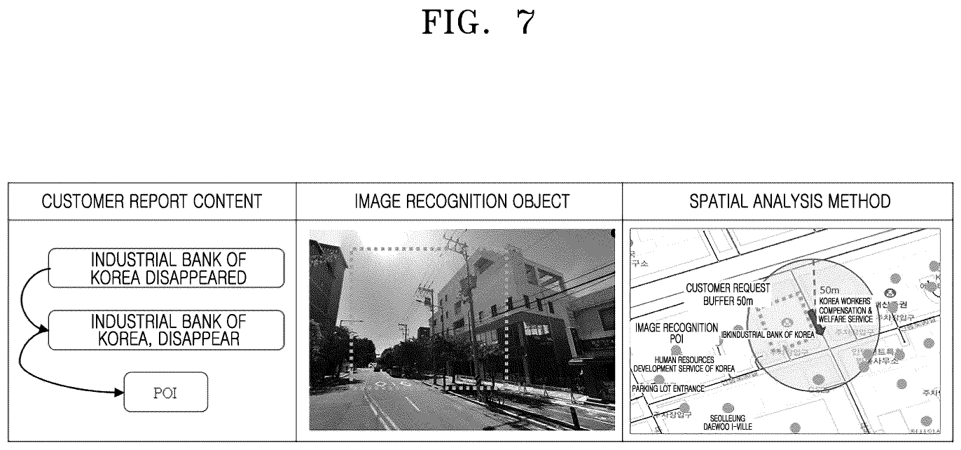

Referring now to FIGS. 1 and 7, the processor 140 may search for the presence or absence of a nearby image-recognized point of interest (POI) within the buffer in consideration of the customer-requested point coordinate buffer 30 m. As a result of the search, when no POI exists, the processor 140 may automatically delete the customer report content (automatically input when there is a new request for addition). Subsequently, worker inspection may be performed.

The devices described above may be implemented as a hardware component, a software component, and/or a combination of hardware components and software components. For example, the devices and components described in the embodiments may be implemented using one or more general-purpose computers or special-purpose computers such as a processor, a controller, an arithmetic logic unit (ALU), a digital signal processor, a microcomputer, a field programmable array (FPA), a programmable logic unit (PLU), a microprocessor, or any other device capable of executing instructions and responding. A processing device may execute an operating system (OS) and one or more software applications executed on the operating system. In addition, the processing device may access, store, manipulate, process, and generate data in response to the execution of the software. For ease of understanding, the processing device may be described as being used alone; however, those having ordinary skill in the art should recognize that the processing device may include a plurality of processing elements and/or a plurality of types of processing elements. For example, the processing device may include a plurality of processors, or one processor and one controller. In addition, other processing configurations such as parallel processors are also possible.

The software may include computer programs, codes, instructions, or combinations of one or more thereof, and may configure a processing device to perform a desired operation or independently or collectively command the processing device. The software and/or data may be permanently or temporarily embodied in any type of machine, component, physical device, virtual equipment, computer storage medium or device, or transmitted signal wave, in order to be interpreted by the processing device or to provide instructions or data to the processing device. The software may be distributed over computer systems connected by a network and stored or executed in a distributed manner. The software and data may be stored on one or more computer-readable recording media.

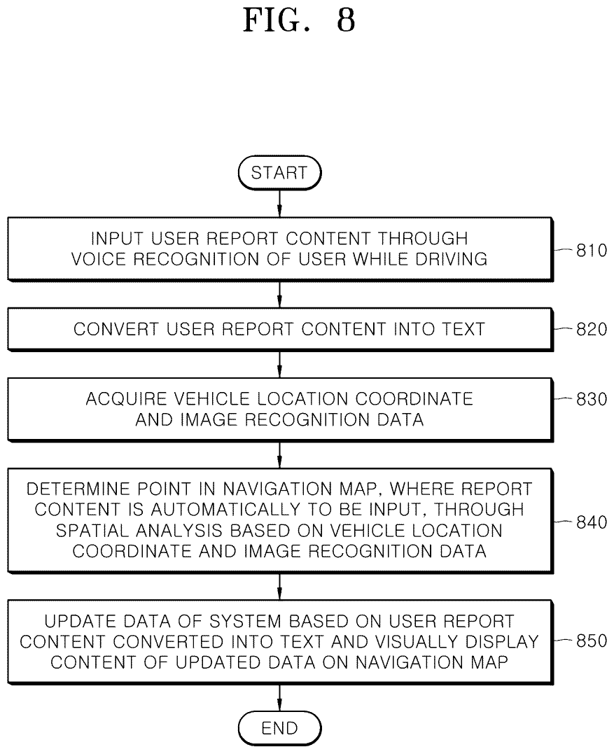

FIG. 8 is a flowchart for explaining a voice report-based navigation map service method in accordance with an embodiment of the present disclosure.

The voice report-based navigation map service method described herein is merely an example embodiment of the present disclosure, and various steps or operations may be added as needed. Since the following steps or operations may also be implemented by changing the order, the present disclosure is not limited to each step or operation and the order to be described below.

Referring to FIGS. 1-8 , in a step or operation S810, the processor 140 may acquire report content of a user and vehicle location coordinates through voice recognition of the user while driving.

In a step or operation S820, the processor 140 may convert the report content of the user into text, and may automatically classify the text into content suitable for a customer's request through machine learning and visualize the classified content. The user report content converted into the text can be stored in the memory 120.

In a step or operation S830, the processor 140 may acquire image recognition data based on the vehicle location coordinates. For example, the processor 140 may acquire image recognition data within a certain radius based on the vehicle location coordinates.

In steps or operations S810 and S830, the voice report-based navigation map service system 100 may be updated by determining a point in the navigation map, where the report content is automatically to be input, through spatial analysis based on the report content and the image recognition data acquired.

The processor 140 may determine a point, in the navigation map, where the user report content converted into the text is to be automatically input, through spatial analysis based on the vehicle location coordinates and the image recognition data.

In a step or operation S850, the processor 140 may update the data of the voice report-based navigation map service system 100 based on the user report content converted into the text, and may visually display content of the updated data on the navigation map. In an embodiment, the processor 140 may display the vehicle location coordinates and the vehicle heading angle on the navigation map together with the user report content.

Although the embodiments have been described by limited examples and drawings as described above, those having ordinary skill in the art can make various corrections and modifications from the above description. For example, appropriate results can be achieved even though the described techniques are performed in a different order from the described method, and/or components of the described system, structure, device, circuit, and the like are joined or combined in a different form from the described method or are replaced or substituted by other components or equivalents.

Accordingly, other implementations, other embodiments, and equivalents to the claims also fall within the scope of the following claims.

What is claimed is:

1. A voice report-based navigation map service system comprising:
a memory; and
a processor configured to:
convert user report content input through voice by a user during driving into text by using voice recognition,
store the text in the memory,
update the user report content converted into the text by using vehicle location coordinates at a time when the user report content is input, and
visually display the updated report content on a navigation map.

2. The voice report-based navigation map service system according to claim 1, wherein the processor is configured to:
acquire image recognition data within a certain radius based on the vehicle location coordinates; and
determine a point where the user report content converted into the text is to be displayed within the navigation map through spatial analysis based on the vehicle location coordinates and the image recognition data.

3. The voice report-based navigation map service system according to claim 1, wherein the processor is configured to:
acquire image recognition data within a certain radius based on the vehicle location coordinates; and
spatially join the vehicle location coordinates and the image recognition data to determine whether changes occur in an actual site corresponding to the user report content.

4. The voice report-based navigation map service system according to claim 1, wherein the processor is configured to:
generate a machine learning model by using a data set related to user report content prepared in advance;
classify requests of the user by using the machine learning model; and
reflect the classified requests in a database.

5. The voice report-based navigation map service system according to claim 4, wherein the processor is configured to:
categorize the user report content converted into the text by using the machine learning model based on the database;
update a result of the categorization; and
visually display the user report content on the navigation map based on a result of the update.

6. The voice report-based navigation map service system according to claim 1, wherein the processor is configured to:
acquire a vehicle heading angle at a time when the user report content is input; and
visually display the vehicle heading angle on the navigation map based on a result of the update together with the user report content converted into the text.

7. The voice report-based navigation map service system according to claim 6, wherein the processor is configured to:
based on determining that a virtual report button displayed on a screen of a navigation terminal is operated,
convert user report content input in voice into text, and
acquire vehicle location coordinates and a vehicle heading angle at a time when the report button is operated.

8. The voice report-based navigation map service system according to claim 6, wherein the processor is configured to:
based on determining that a physical report button provided on one side of a navigation terminal is operated,
convert user report content input in voice into text, and acquire vehicle location coordinates and a vehicle heading angle at a time when the report button is operated.

9. A voice report-based navigation map service method comprising:
converting, by a processor, user report content input through voice by a user during driving into text by using voice recognition;
storing, by the processor, the text in a memory;
updating, by the processor, the user report content converted into the text by using vehicle location coordinates at a time when the user report content is input; and
visually displaying the updated report content on a navigation map.

10. The voice report-based navigation map service method according to claim 9, wherein visually displaying the updated report content on the navigation map includes:
acquiring image recognition data within a certain radius based on the vehicle location coordinates; and
determining a point where the user report content converted into the text is to be displayed within the navigation map through spatial analysis based on the vehicle location coordinates and the image recognition data.

11. The voice report-based navigation map service method according to claim 9, wherein visually displaying the updated report content on the navigation map includes:
acquiring image recognition data within a certain radius based on the vehicle location coordinates; and
spatially joining the vehicle location coordinates and the image recognition data to determine whether changes occur in an actual site corresponding to the user report content.

12. The voice report-based navigation map service method according to claim 9, further comprising:
generating, by the processor, a machine learning model by using a data set related to user report content prepared in advance;
classifying, by the processor, requests of the user by using the machine learning model; and
reflecting, by the processor, the classified requests in a database.

13. The voice report-based navigation map service method according to claim 12, wherein visually displaying the updated report content on the navigation map includes:
categorizing the user report content converted into the text by using the machine learning model based on the database; and
updating a result of the categorization and visually displaying the user report content on the navigation map based on a result of the update.

14. The voice report-based navigation map service method according to claim 9, wherein visually displaying the updated report content on the navigation map includes:
acquiring a vehicle heading angle at a time when the user report content is input; and
visually displaying the vehicle heading angle on the navigation map based on a result of the update together with the user report content converted into the text.

15. The voice report-based navigation map service method according to claim 14, wherein acquiring the vehicle heading angle includes:
converting user report content input in voice into text based on determining that a virtual report button displayed on a screen of a navigation terminal is operated; and
acquiring vehicle location coordinates and a vehicle heading angle at a time when the report button is operated.

16. The voice report-based navigation map service method according to claim 14, wherein acquiring the vehicle heading angle includes:
converting user report content input in voice into text based on determining that a physical report button provided on one side of a navigation terminal is operated; and
acquiring vehicle location coordinates and a vehicle heading angle at a time when the report button is operated.

17. A voice report-based navigation map service system comprising:
a memory; and
a server configured to:
receive voice data, vehicle location coordinates, and a vehicle heading angle from a navigation terminal;
convert the voice data into text;
store the text in the memory together with the vehicle location coordinates and the vehicle heading angle; and
generate navigation information by using the text, the vehicle location coordinates, and the vehicle heading angle.

18. The voice report-based navigation map service system according to claim 17, wherein the server is configured to provide the navigation information to the navigation terminal to visually display user report content on a navigation map of the navigation terminal.

19. The voice report-based navigation map service system according to claim 18, wherein the server is configured to:
acquire image recognition data within a certain radius based on the vehicle location coordinates; and
determine a point where the user report content converted into the text is to be displayed within the navigation map through spatial analysis based on the vehicle location coordinates and the image recognition data.

20. The voice report-based navigation map service system according to claim 17, wherein the server is configured to:
generate a machine learning model by learning a data set related to user report content stored in a database;
classify requests of the user by using the machine learning model;
reflect the classified requests in a database;
categorize the user report content converted into the text by using the machine learning model based on the database to update a result of the categorization; and
generate the navigation information based on a result of the update.
